(19) United States
(12) Patent Application Publication
(10) Pub. No.: US 2005/0278110 A1
(43) Pub. Date: Dec. 15, 2005

(54) Vehicle navigation system

(75) Inventor: Shinichi Horio, Takahama-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/094,503

(22) Filed: Mar. 31, 2005

(30) Foreign Application Priority Data
Mar. 31, 2004 (JP) 2004-106195

(51) Int. Cl. G01C 21/26; G06F 7/00

(52) U.S. Cl. 701/200; 701/29

(57) ABSTRACT

A control unit of a vehicle navigation system receives a voice input signal collected from a microphone included in a voice input unit when a synthesized voice is outputted from a voice output unit. An analog-to-digital converter of the control unit converts the voice input signal to a digital signal and a voice recognition circuit performs voice recognition on the digital signal. The control unit compares a result of the voice recognition with voice data. A synthesized voice signal produced by an output control circuit of the control unit via a digital-to-analog convert of the control unit is inputted to the analog-to-digital converter. The voice recognition circuit performs voice recognition on the synthesized voice signal. The control unit compares a result of the voice recognition with voice data. The control unit detects failures based on the results and the detected failures are stored in a data storage.

### CROSS REFERENCE TO RELATED APPLICATION

This application is based on and incorporates herein by reference Japanese Patent Application No. 2004-106195 filed on Mar. 31, 2004.

### FIELD OF THE INVENTION

The present invention relates to a vehicle navigation system having a voice input unit.

### BACKGROUND OF THE INVENTION

Vehicle navigation systems are equipped with voice input units (voice recognition units) and voice output units. The voice input and output units are provided for improving usability and safety of the vehicle navigation systems. Users can input commands for operating the vehicle navigation systems, such as setting a destination or change map scales, through voice inputs via microphones. Audio guidance is produced by a voice synthesizer and provided through speaker when guiding a route. Users can hear a voice saying, for example, “turn left at an intersection 200m ahead.”

Current models of vehicle navigation systems have self-diagnosis functions for diagnosing audio systems, air-conditioning systems, and engine control computers. One of such vehicle navigation systems is proposed in JP-A-2002-257692. This navigation system also has a function for diagnosing its voice output unit.

However, a cause of malfunction in a voice output unit is not easily identified if the cause is related to bad electrical contact. As a result, replacement of a whole unit and burdensome checking are required when the cause cannot be identified. This is not efficient nor effective for the diagnosis of the voice output unit.

### SUMMARY OF THE INVENTION

The present invention therefore has an objective to provide a vehicle navigation system having voice input and output units and a diagnostic function for detecting failures including a temporal failure of the voice output unit. A vehicle navigation system of the present invention includes a voice input unit, a data load unit, a control unit, and a voice output unit.

The voice input unit receives a voice input from a user and outputs a voice input signal related to the voice input. The data load unit loads data including voice data from a data storing medium. The control unit controls operation of the vehicle navigation system and performs a diagnosis of the vehicle navigation system. The voice output unit outputs a synthesized voice produced based on the voice signal.

The control unit includes voice recognition means, output control means, diagnostic means, and data storing means. The voice recognition means performs voice recognition on the voice input signal from the voice input unit. The output control means reads appropriate voice data from the data load unit and outputs a voice signal corresponding to the voice data. The diagnostic means performs a diagnosis of the voice output unit by comparing a result of the voice recognition performed on the voice input signal with the voice data. The data storing mean stores a result of the diagnosis.

The result of the voice recognition should match the voice data if the voice output unit normally functions. Thus, whether the voice output unit functions normally is determined based on a result of the comparison. The diagnosis of the voice output unit is automatically performed under a normal operating condition. The result of the diagnosis is stored in the storing means. Therefore, a failure of the voice output unit is properly detected by analyzing the result stored in the storing means even if the failure is temporal.

### BRIEF DESCRIPTION OF THE DRAWINGS

The above and other objectives, features and advantages of the present invention will become more apparent from the following detailed description made with reference to the accompanying drawings. In the drawings:

FIG. 1 is a block diagram of a vehicle navigation system according to an embodiment of the present invention;

FIG. 2 is a block diagram of voice input and output portions of the vehicle navigation system according to the embodiment; and

FIG. 3 is a flowchart of a self-diagnosis process according to the embodiment.

### DETAILED DESCRIPTION OF THE PREFERRED EMBODIMENT

The preferred embodiments of the present invention will be explained with reference to the accompanying drawings. In the drawings, the same numerals are used for the same components and devices,

### First Embodiment

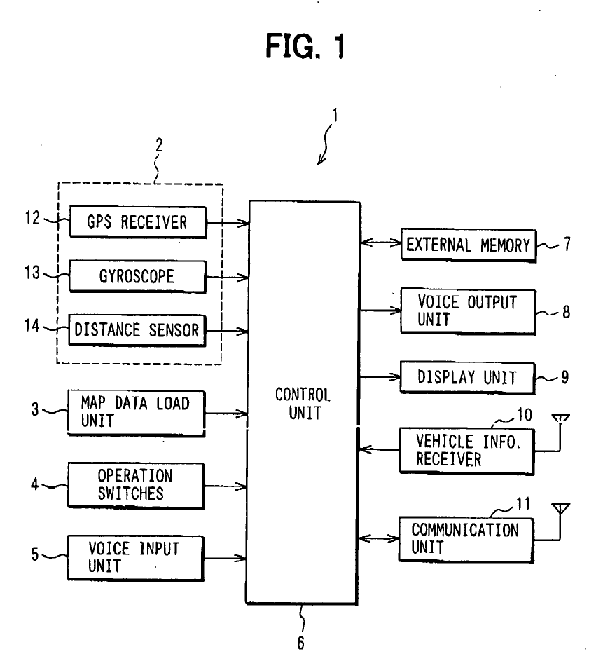

Referring to FIG. 1, a vehicle navigation system 1, installed in a vehicle, includes a position detection unit 2, a map data load unit 3, operation switches 4, a voice input unit 5, a control unit 6, an external memory 7, a voice output unit 8, a display unit 9, a vehicle information receiver 10, and a communication unit 11. The control unit 6 is connected to the position detection unit 2, the map data load unit 3, the operation switches 4, and the voice input unit 5. The external memory 7 is connected to the control unit 6. The display unit 9 is, for example, a liquid crystal display (LCD).

The position detection unit 2 includes a global positioning system (GPS) receiver 12, a gyroscope 13, and a distance sensor 14. The GPS receiver 12 receives radio wave signals from a GPS satellite for detecting a position of the vehicle based on the signals. The gyroscope 13 detects rotation angle speeds of the vehicle. The distance sensor 14 detects travel distances of the vehicle, The control unit 6 determines a current position, a travel direction, a speed, a travel distance of the vehicle and the current time based on the inputs from the GPS receiver 12, the gyroscope 13, and the distance sensor 14 with high accuracy.

The map data load unit 3 is a drive unit for loading data including road map data and map matching data from a data storing medium. The map matching data is used for improving accuracy in the position detection. The data storing medium is a mass-storage device such as a CD-ROM and a DVD. Voice data for route guidance is also included in the data. The road map data includes shapes, widths, names of roads, buildings, points of interest, phone numbers of the points of interest, name of places and geographic features. It also includes information for reproducing a road map on the display unit 9.

The operation switches 4 includes various mechanical switches through which the user can inputs commands for operating the navigation system 1, for instance, setting a destination or selecting a kind of map for display. The operation switches 4 also include touch switches (not shown) on a touch panel of the display unit 9. The external memory 7 stores data on a route to a destination set by the control unit 6 during route guidance.

The display unit 9 displays road maps at different scales and a pointer indicating the current position and the travel direction of the vehicle on the map. It also displays input screens, messages, and information. The user can input information, such as a destination, through the input screen. The display unit 9 displays guide routes on the road maps during route guidance for guiding a route to a destination.

The control unit 6 includes a known microcomputer as a main unit. The microcomputer includes a CPU, a ROM, and a RAM. The control unit 6 receives the map data from the map data load unit 3 and controls the display unit 9 for displaying the road map based on the map data. It receives data from the position detection unit 2 and controls the display unit 9 for displaying the pointer based on the data. It performs map matching so that the pointer is displayed on a road in the map. It also controls the display unit 9 for changing the kind of the map, namely, changing scales of the map based on a command inputted by the user.

The control unit 6 performs an automatic route search function and a route guidance function. The automatic route search function is for automatically calculating a recommended route from the current position to a destination inputted by the user. The route guidance function is for displaying a route on the map for guiding the user to the destination, and for outputting audio guidance, such as “turn left at an intersection 200m ahead,” from the voice output unit 8 at a proper timing.

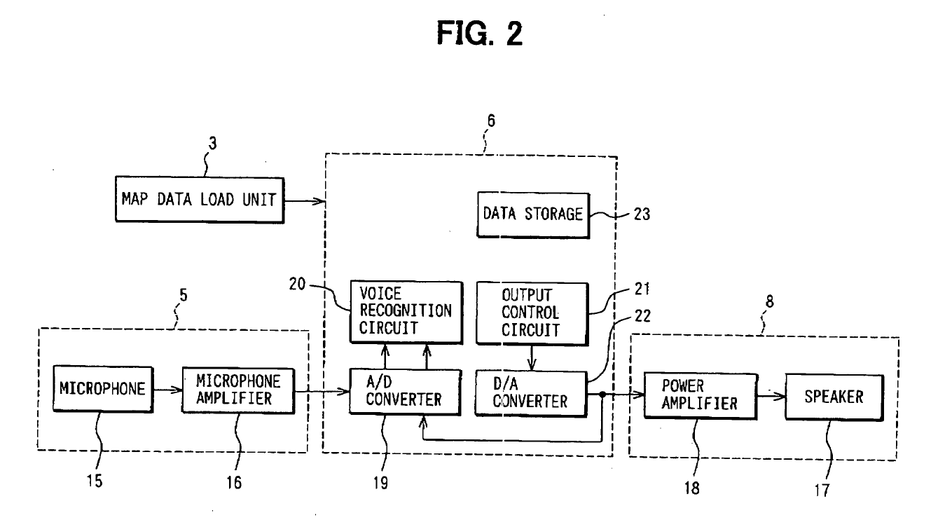

Voice input and output functions will be discussed referring to FIG. 2. The voice input device 5 includes a microphone 15, a microphone amplifier 16, and a talk switch (not shown). The use can input voice commands through the microphone 15. The microphone amplifier 16 amplifies audio signals (voice input signals) inputted from the microphone 15 and inputs the amplified audio signals to the control unit 6. The talk switch indicates a start of voice input by the user. The user can input instructions including commands and destinations without looking down when the talk switch is turned on for substituting the manual input through the operation switches 4.

The voice output unit 8 includes speaker 17 and a power amplifier 18. The speaker outputs a synthesized voice related to the route guidance. The power amplifier 18 amplifies a synthesized voice signal (audio signal) outputted from the control unit 6 and inputs to the speaker 17. The user hears voice guidance such as “turn left at an intersection 200m ahead,” “turn right shortly,” and “keep on straight ahead for a while.”

The microphone 15 is arranged at a position suitable for picking up a user's voice, for example, on a steering column cover or on a driver's seat side visor. The talk switch is arranged on the left side of the steering column cover or around a shift lever so that the user can manipulate it with his or her left hand in a case of a right-hand driver vehicle. The speaker 17 is arranged at an instrument panel. The speaker 17 is connected with the power amplifier 18 via connectors and wire harnesses. The power amplifier 18 is connected with the control unit 6 via connectors and wire harnesses.

The control unit 6 includes an analog-to-digital (A/D) converter 19, a voice recognition circuit 20, an output control circuit 21, a digital-to-analog converter 22, and a data storage 23 via hardware or software configurations. The A/D converter 19 converts the voice input signal, which is an analog signal, to digital data, and inputs it to the voice recognition circuit 20. The voice recognition circuit 20 performs a voice recognition on the voice input signal by a known method using dictionary data, audio models, and language models stored in advance.

The output control circuit 21 reads appropriate voice data from the map data load unit 3, and inputs a voice signal corresponding to the voice data to the D/A converter 22 at an appropriate timing. The D/A converter 22 converts the voice signal, which is digital signal, to an analog signal, and inputs it to the power amplifier 18 as a synthesized voice signal. The synthesized voice signal outputted from the D/A converter 22 is also inputted to the A/D converter 19 of the control unit 6.

The control unit 6 drives the microphone 15 and receives the voice input signal from the voice input unit 5 when the synthesized voice signal is outputted from the voice output device 8 of the speaker 17, namely, the voice data is outputted form the output control circuit 21. Then, it controls the A/D converter 19 and the voice recognition circuit 20 to perform the voice recognition on the voice input signal, and determines whether the results of the voice recognition match the voice data. If they do not match, the voice output unit 8 is determined defective, and the result is stored in the data storage 23.

At the same time, the control unit 6 receives the synthesized voice signal outputted from the D/A converter 22 through the A/D converter 19, and controls the voice recognition circuit to perform voice recognition on the synthesized voice signal. Then, it determines whether the result of the voice recognition matches the voice data. If they do not match, the control unit 6 is determined defective, and the result is stored in the data storage 23.

The above-described operations are performed every time when the synthesized voice signal is outputted from the voice output unit 8, namely, the voice data is outputted from the output control circuit 21. The control unit 6 functions as voice output diagnostic means and data diagnostic means. The data storage 23 functions as a storing means for storing results of the comparison.

The user, or the driver, can input commands and destinations through the operation of the operation switches 4 for desired map display, automatic route search, and route guidance. The user can input such commands and destinations through voice inputs from microphone 15 of the voice input unit 5.

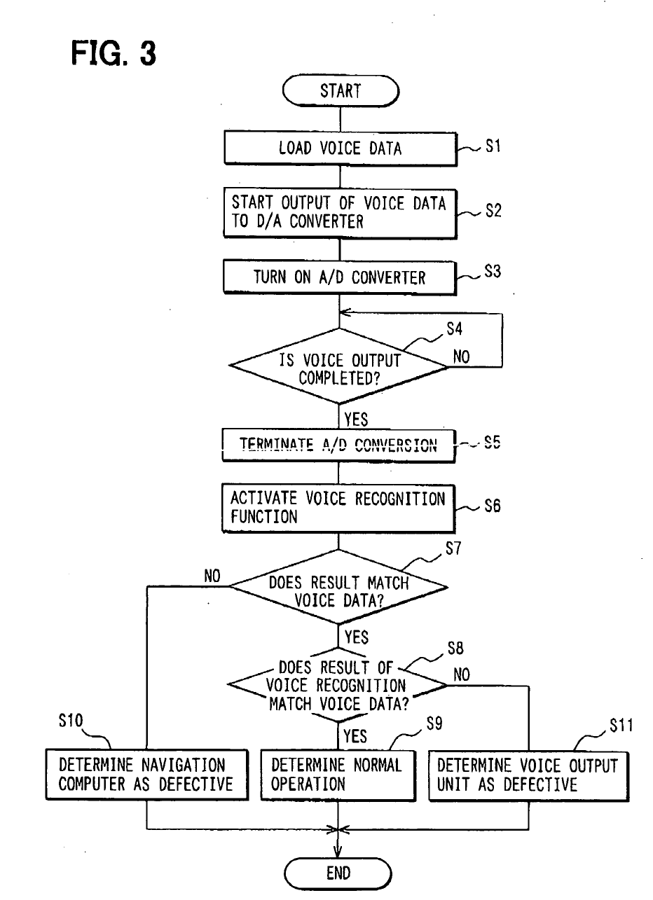

The current position of the vehicle and the direction to travel are indicated on a road map displayed on the display unit 9 during the route guidance. The audio guidance, such as “turn left at an intersection 200m ahead,” “turn right shortly,” and “keep on straight ahead for a while,” is outputted from the speaker 17 of the voice output unit 8 during the route guidance. The control unit 6 performs self-diagnosis on the voice input and output functions during normal operation. A process of the self-diagnosis is shown in FIG. 3.

The voice data to be outputted is loaded from the map data load unit 3 when audio guidance with a synthesized voice is necessary to be outputted from the voice output unit 8 (S1). An output of the voice data from the output control circuit 21 to the D/A converter 22 is started (S2). In this step, the voice data is converted into analog data (synthesized voice signal) by the D/A converter 22 and inputted to the power amplifier 18, and the synthesized voice is outputted from the speaker 17. The synthesized voice signal outputted from the D/A converter 22 is also inputted to the A/D converter 19.

The A/D converter 19 and the voice input unit 5 are turned on and data collection by the AND converter 19 is started (S3). The synthesized voice outputted from the speaker 17 is collected by the microphone 15. The A/D converter 19 receives the synthesized voice signal directly from the D/A converter 22 and the voice input signal from the voice input unit 5. The A/D converter 19 performs A/D conversion on the synthesized voice signal and the voice input signal.

The control unit 6 determines whether the voice output from the speaker 17 is completed (S4). If so, the A/D conversion by the A/D converter 19 is terminated (S5). The voice recognition function is activated and a voice recognition process is performed by the voice recognition circuit 20 (S6). The voice recognition process is performed on the synthesized voice signal and the voice input signal.

The control unit 6 determines whether a result of the voice recognition on the synthesized voice signal outputted from the D/A converter 22 matches the voice data (S7). If the synthesized voice signal is property outputted from the output control circuit 21, the result of the voice recognition should match the voice data. Therefore, the control unit 6 determines whether the synthesized voice signal is a proper signal by comparing it with the voice data. If the result matches the voice data (yes at step S7), the self-diagnosis process proceeds to step S8.

The control unit 6 determines whether a result of the voice recognition on the voice input signal matches the voice data (S8). If the voice input signal is properly outputted form the speaker 17, the result of the voice recognition should match the voice data. Therefore, the control unit 6 determines whether the voice output unit 8 is properly operating by comparing the voice input signal with the voice data. If the result matches the voice data (yes at step S8), the control unit 6 determines that the voice output function, that is, the output control circuit 21, the D/A converter 22, and the voice output unit 8, is normally operating (S9), and completes the self-diagnosis process.

If the result of the voice recognition on the synthesized voice signal does not match the voice data (no at step S7), the control unit 6 determines that the synthesized voice signal is abnormal and the navigation computer is detective (S10). Date and time when the detective navigation computer is determined and a kind of the defect are stored in the data storage 23.

If the result of the voice recognition on the voice input signal does not match the voice data although the synthesized voice signal is determined as normal (no at step S8), the control unit 6 determines that the voice output unit 8 is detective (S11). Date and time when the defective voice output unit 8 is determined and a kind of the defect are stored in the data storage 23. This process is performed every time when the synthesized voice is outputted from the voice output unit 8.

The user may bring the vehicle to a car dealer for repair when the voice output unit 8 becomes faulty, for example, no voice guidance is outputted from the voice output unit 8 even though the voice guidance function is turned on. In such a case, a service person can easily obtain information on time and time of previous failure of the voice output unit 8 and a kind of the failure by reading data from the diagnosis history stored in the data storage 23. The data storage 23 stores data on a kind of the failure, namely, data indicating that either the control unit 6 or the voice output unit 8 is defective. Thus, the failure is easily located and fixed.

The failure is easily located by reading the data from the diagnosis history even when it cannot be reproduced at the dealer, in such a case that the failure temporarily occurs due to bad connection in wire harnesses or connectors. Therefore, checks and repairs are easily performed and unnecessary parts replacement can be reduced.

With the above-described configuration, the vehicle navigation system 1 automatically performs the self-diagnosis on the voice output unit 8 and stores the history of the self-diagnosis in the data storage 23. Thus, a diagnosis of the voice output unit 8 can be performed by analyzing the data stored in the data storage 23 even when a failure is temporal.

Furthermore, the synthesized voice signal is inputted from the D/A convert 22 to the A/D converter 19 and the voice recognition is performed by the voice recognition circuit 20. The control unit 6 compares the result of the voice recognition with the voice data and determines whether the result matches the voice data. Then, it determines whether the synthesized voice signals is normally outputted based on the determination. Thus, the failure is easily determined.

The self-diagnosis is performed every time when the synthesized voice is outputted from the voice output unit 8. Namely, the self-diagnosis is frequently performed without instruction from the user.

The present invention should not be limited to the embodiment previously discussed and shown in the figures, but may be implemented in various ways without departing from the spirit of the invention. For example, the self-diagnosis of the voice output unit 8 can be performed without the synthesized voice signal inputted from the D/A converter 22 to the A/D converter 19. The self-diagnosis may be performed when a predetermined time has elapsed since the previous self-diagnosis.

1. A vehicle navigation system having a voice input unit that inputs commands and a destination through voice input, voice recognition means that performs voice recognition based on a voice input signal inputted from the voice input unit, voice output unit that outputs a synthesized voice for route guidance, and output control means that outputs a synthesized voice signal corresponding to voice data to be outputted, the vehicle navigation system comprising:
voice output diagnostic means that controls the voice recognition means to receive a voice input signal from the voice input unit, to perform voice recognition on the voice input signal, and to determine whether a result of the voice recognition matches the voice data corresponding to the voice input signal when the synthesized voice is outputted from the voice output unit; and
data storing means that stores a history of diagnoses performed by the voice output diagnostic means.

2. The vehicle navigation system according to claim 1, wherein the voice output diagnostic means performs the diagnoses every time when the synthesized voice is outputted from the voice output unit.

3. The vehicle navigation system according to claim 1, further comprising voice data diagnostic means that controls the voice recognition means to receive a synthesized voice signal from the voice output unit, to perform voice recognition on the synthesized voice signal, and to determine whether a result of the voice recognition matches the voice data corresponding to the synthesized voice signal when the synthesized voice is outputted from the output control means, wherein the data storing means stores a history of diagnoses performed by the voice data diagnostic means.

4. The vehicle navigation system according to claim 3, wherein the voice data diagnostic means performs the diagnoses every time when the synthesized voice is outputted from the output control means.

5. A vehicle navigation system having a voice input unit that inputs commands and a destination through voice input, voice recognition means that performs voice recognition based on a voice input signal inputted from the voice input unit, voice output unit that outputs a synthesized voice for route guidance, and output control means that outputs a synthesized voice signal corresponding to voice data to be outputted, the vehicle navigation system comprising:
voice data diagnostic means that controls the voice recognition means to receive a synthesized voice signal from the output control unit, to perform voice recognition on the synthesized voice signal, and to determine whether a result of the voice recognition matches the voice data corresponding to the synthesized voice signal when the synthesized voice is outputted from the output control unit; and
data storing means that stores a history of diagnoses performed by the voice data diagnostic means.

6. The vehicle navigation system according to claim 5, wherein the voice data diagnostic means performs the diagnoses every time when the synthesized voice is outputted from the output control means.

7. The vehicle navigation system according to claim 5 further comprising voice output diagnostic means that controls the voice recognition means to receive a voice input signal from the voice input unit, to perform voice recognition on the voice input signal, and to determine whether a result of the voice recognition matches the voice data corresponding to the voice input signal when the synthesized voice is outputted from the voice output unit, wherein the data storing means that stores a history of diagnoses performed by the voice output diagnostic means.

8. The vehicle navigation system according to claim 1, wherein the voice output diagnostic means performs the diagnoses every time when the synthesized voice is outputted from the voice output unit.

9. A vehicle navigation system comprising:
a voice input unit that receives a voice input from a user and outputs a voice input signal related to the voice input;
a data load unit that loads data including voice data from a data storing medium;
a control unit that controls operation of the vehicle navigation system and performs a diagnosis of the vehicle navigation system; and
a voice output unit that outputs a synthesized voice produced based on the voice input signal, wherein
the control unit includes voice recognition means, output control means, voice output diagnostic means, and data storing means,
the voice recognition means performs voice recognition on the voice input signal from the voice input unit,
the output control means reads appropriate voice data from the data load unit and outputs a voice signal corresponding to the voice data,
the voice output diagnostic means compares a result of the voice recognition performed on the voice input signal with the voice data, and
the data storing means stores a result of the comparison.

10. The vehicle navigation system according to claim 9, wherein the diagnostic means performs the diagnosis every time when the synthesized voice is outputted from the voice output unit.

11. The vehicle navigation system according to claim 9, wherein:
the control means further including voice data diagnostic means;
the output control means also inputs the voice signal to the voice recognition means;
the voice recognition means performs voice recognition on the voice signal from the output control means;
the voice data diagnostic means compares a result of the voice recognition performed on the voice signal with the voice data; and
the data storing means stores a result of the comparison.

12. The vehicle navigation system according to claim 11, wherein the voice data diagnostic means performs the diagnosis every time when the synthesized voice is outputted from the output control means.

13. A vehicle navigation system comprising:
a voice input unit that receives a voice input from a user and outputs a voice input signal related to the voice input;
a data load unit that loads data including voice data from a data storing medium;
a control unit that controls operation of the vehicle navigation system and performs a diagnosis of the vehicle navigation system; and
a voice output unit that outputs a synthesized voice produced based on the voice input signal, wherein
the control unit includes output control means, voice recognition means, voice data diagnostic means, and data storing means,
the output control means reads appropriate voice data from the data load unit and outputs a voice signal corresponding to the voice data,
the output control means inputs the voice signal to the voice recognition means,
the voice recognition means performs voice recognition on the voice signal from the output control means,
the voice data diagnostic means compares a result of the voice recognition performed on the voice signal with the voice data, and
the data storing means stores a result of the comparison.

14. The vehicle navigation system according to claim 13, wherein the voice data diagnostic means performs the diagnosis every time when the synthesized voice is outputted from the output control means.

15. The vehicle navigation system according to claim 13, wherein:
the control means further including voice output diagnostic means;
the voice recognition means performs voice recognition on the voice input signal from the voice input unit;
the voice output diagnostic means compares a result of the voice recognition performed on the voice input signal with the voice data; and
the data storing means stores a result of the comparison.

16. The vehicle navigation system according to claim 15, wherein the voice output diagnostic means performs the diagnosis every time when the synthesized voice is outputted from the voice output unit.
